(19) United States
(12) Patent Application Publication
(10) Pub. No.: US 2019/0390477 A1
(43) Pub. Date: Dec. 26, 2019

(54) APPARATUSES AND METHODS FOR EXTENDING A VEHICLE GRAB HANDLE

(71) Applicant: John Wayne Yakimyshyn, Surrey (CA)

(72) Inventor: John Wayne Yakimyshyn, Surrey (CA)

(21) Appl. No.: 16/447,720

(22) Filed: Jun. 20, 2019

Related U.S. Application Data
(60) Provisional application No. 62/687,254, filed on Jun. 20, 2018.

(51) Int. Cl. E05B 1/00; B60N 5/00

(52) U.S. Cl. CPC E05B 1/0053; B60N 5/00

(57) ABSTRACT

Apparatus and methods for assisting a user to enter a vehicle are provided. The apparatus includes a coupler for coupling to a vehicle's grab handle and a handle for a user to grasp and pull themselves up by. The handle is coupled to the coupler. The handle includes a gripping portion, wherein the gripping portion is shaped and sized for grasping by a user. A coupling portion is coupled to the gripping portion, wherein the coupling portion is for coupling the handle to the coupler. The coupler may include a first piece for fitting around the grab handle, where the first piece includes a bearing surface for bearing against the grab handle when being used by the user. The coupler may also include an attachment piece for attaching each end of the first piece to and for coupling to the handle.

### TECHNICAL FIELD

The present disclosure relates to vehicle accessories. More particularly, the present disclosure is directed to apparatuses and methods for extending vehicle grab handles to assist users climb into a vehicle.

### BACKGROUND

The use of vehicles such as SUVs has grown in recent years. Entering and exiting a vehicle may be difficult for some drivers and passengers. In some situations, the floor of the entryway may be high for the passenger or driver. For example, the floorboards of an SUV might be high enough that a driver or a passenger needs to climb up into the seat. Shorter people may have a greater climb and may struggle more climbing into an automobile. Climbing up into the seat may lead to risks of losing one's balance or falling. People with disabilities may also struggle climbing into an automobile.

There exists a continuing desire to advance and improve apparatus and methods for entering vehicles.

### SUMMARY

According to one aspect set forth in this disclosure, there is provided an apparatus for assisting a user to enter a vehicle. The apparatus may include a coupler for coupling to a vehicle's grab handle and a handle for a user to grasp and pull themselves up by. The handle is coupled to the coupler.

The handle may include a gripping portion. The gripping portion may be shaped and sized for grasping by a user. The handle may also include a coupling portion coupled to the gripping portion. The coupling portion is for coupling the handle to the coupler.

The coupler may include a first piece for fitting around the grab handle. The first piece may include a bearing surface for bearing against the grab handle when being used by the user. The coupler may also include an attachment piece for attaching each end of the first piece to and for coupling to the handle.

According to another aspect, there is provided a method for attaching an apparatus for assisting a user into a vehicle to a grab handle of the vehicle. The method includes positioning a coupler of the apparatus around the grab handle by looping a first piece of the coupler around the grab handle, coupling a handle to an attachment piece and attaching the first piece to the attachment piece.

### BRIEF DESCRIPTION OF THE DRAWINGS

In the accompanying drawings, which illustrate one or more example embodiments,

FIG. 1 shows an embodiment of an apparatus for coupling to an automobile grab-handle;

FIG. 2 shows another embodiment of an apparatus for coupling to an automobile grab-handle;

FIGS. 3a and 3b show another embodiment of an apparatus for coupling to an automobile grab handle; and

FIG. 4 shows several embodiments of a grab handle extender.

### DETAILED DESCRIPTION

Directional terms such as “top”, “bottom”, “upper”, “lower”, “left”, “right”, and “vertical” are used in the following description for the purpose of providing relative reference only, and are not intended to suggest any limitations on how any article is to be positioned during use, or to be mounted in an assembly or relative to an environment unless otherwise stated. Additionally, the term “couple” and variants of it such as “coupled”, “couples”, “coupling”, and “coupleable” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections. The term “coupleable”, as used in the present disclosure, means that a first device is capable of being coupled to the second device.

Entering an automobile may be a struggle for some individuals. For example, in some cases, entering an automobile may require climbing up into the automobile. Some people may use both hands to climb in, making it difficult to hold anything while climbing in. People with poor balance or physical disabilities may also have a difficult time climbing up into an automobile.

The present disclosure provides apparatus and methods for assisting a person climbing into an automobile. The apparatus may be coupled to a grab handle. Grab handles are generally positioned above or to the side of an entryway of an automobile. The apparatus may hang from the grab handle and may be grasped by a user and used to assist the user in pulling the user into the vehicle.

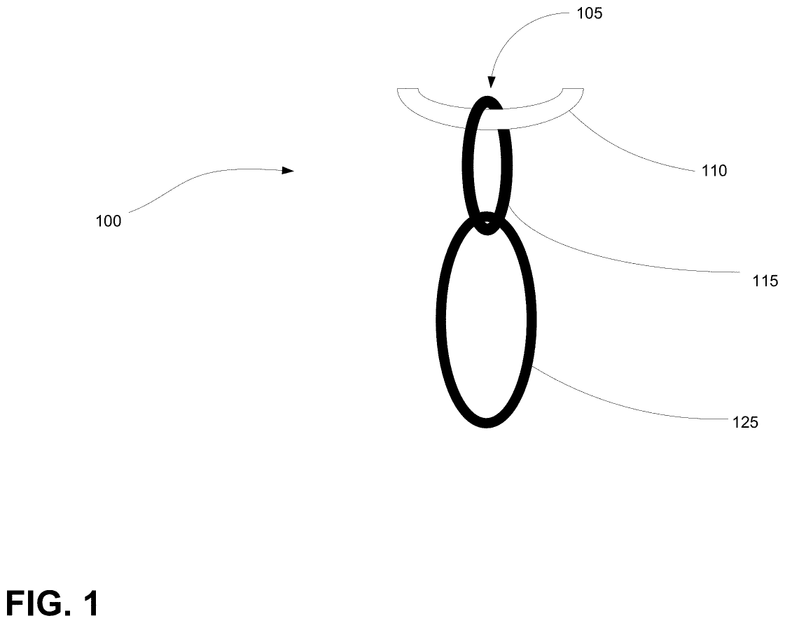

In accordance with some embodiments, the apparatus may be a grab handle extender. It may be coupleable to a grab handle and hang from the grab handle once coupled. Any suitable method of coupling the apparatus to a grab handle may be used. For example, in some embodiments, the apparatus may have a hook like end for hooking onto the grab handle. In some embodiments, as shown in FIG. 1, a coupling end 105 of the apparatus 100 may pass in the space between the grab handle 110 and the vehicle surface that the grab handle 110 is attached to and form a closed loop 115. One end of the apparatus 100 may be connected to another portion of the apparatus 100 to form a loop 115. Any suitable connection may be used. For example, fasteners such as, without limitation, rivets, screws, or bolts may be used. In some cases, Velcro may be used for joining the apparatus to form a loop.

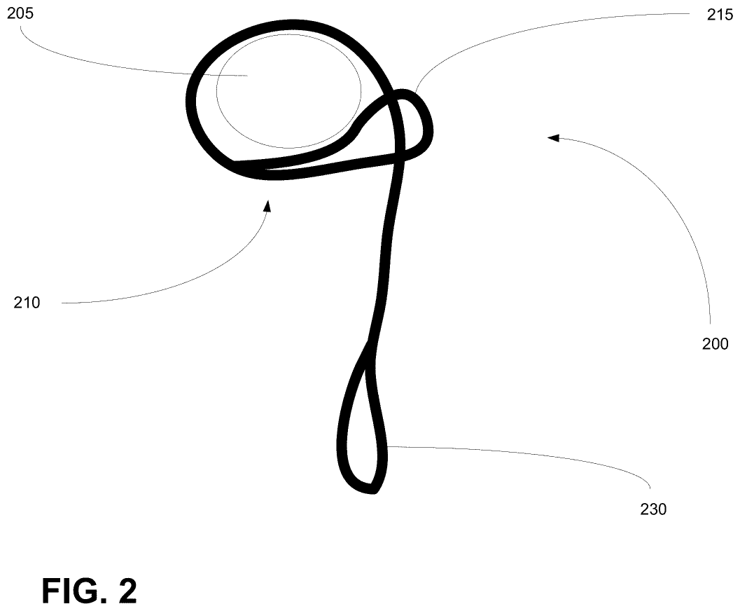

In some embodiments, as shown in FIG. 2, an end of the apparatus 200 may be tied to the grab handle 205. The fastening end 210 may be sufficiently flexible to form a knot around the grab handle 205. In certain embodiments, the fastening end may have a loop 215. For fastening, the loop may be passed through the space between the grab handle 205 and the surface of the automobile that the grab handle 205 is attached to. The other end 220 of the apparatus 200 may be passed through the loop 215, thereby fastening the apparatus 200 to the grab handle 205.

Any suitable loop may be used for passing the second end of the apparatus through. For example, a loop may be formed at the fastening end (the coupler or coupling end) of the apparatus by attaching the end to a portion of the apparatus away from the end. In these embodiments, the loop is formed from the end of the apparatus itself by turning the end of the apparatus into a loop. In some embodiments, a loop may be coupled to the end of the apparatus. For example, a ring or loop may be fastened to the end of the apparatus. For coupling the apparatus to the grab handle, the loop may be passed through the space between the grab handle and the surface that the grab handle is attached to and the second end of the apparatus may be passed through the loop. Pulling on the second end may be used for tightening the apparatus' coupling to the grab handle.

The loop coupled to the end of the apparatus may be formed of any suitable material. For example, and without limitation, the loop may be formed of metal, plastic, ceramic fabric, leather, polymer or any other suitable material. Composites may also be used.

The grabbing end, or handle, of the apparatus may be used for holding by a user to assist the user in climbing up into the automobile. The handle may have any suitable shape, size, and composition for grabbing and pulling. For example, referring again to FIG. 1, in some embodiments, the handle 125 may include a loop or be formed of a portion of a loop. In some embodiments, the loop at the handle may be coupled to a fastening end loop, similar to links in a chain.

In some embodiments, the handle may have an enlarged portion at the bottom to provide a grip for holding onto or to prevent sliding of a hand that is holding the portion above the enlarged portion. In certain embodiments, knots at the handle may provide a grip. In some embodiments, the surface of the handle may be a gripping surface. For example, the surface may be contoured or have roughness to increase friction. Any suitable anti-slip surface treatment may be used to increase the gripability of the apparatus.

Referring to FIG. 2, in some embodiments, the grabbing portion or handle 230 may be a straight portion, such as a leather strap. In some cases, the handle 230 may be formed of multiple pieces such as tassels. The handle may, in certain embodiments, be formed of material that is soft on the hands, such as leather (without limitation).

In some embodiments, the handle may be directly connected to the coupler or fastening end. In some embodiments, the coupler and the handle may be coupled through a body portion. In certain embodiments, the body portion may be used for adding length to the apparatus. In embodiments where the second end or handle of the apparatus may be passed through a loop at the fastening end (coupler) of the apparatus, the body portion may be sized and shaped to pass through the loop. The body portion may also be made of a material and sized and shaped to be sufficiently flexible to pass through the loop. Having sufficient flexibility depends on the length of the apparatus and the size of the loop. For smaller loops or a longer apparatus, greater flexibility may be used so that the apparatus will bend enough to pass through the loop.

The apparatus may be of any suitable size. For example, in some embodiments, the length of the apparatus may be long enough for a user to reach while standing outside the automobile. In certain embodiments, the length of the apparatus may be at least six inches.

In some embodiments, the length of the apparatus may be adjustable. For example, the apparatus may comprise a strap with a slide buckle for adjusting the length. Any suitable length adjusting mechanism may be used.

The ends and the body portion of the apparatus may have any suitable cross-sectional shape. For example, in some embodiments, the apparatus may be a strap. In some embodiments, the apparatus may include a portion with, for example, a circular or square cross-section. Chords or rope like pieces may be used in the apparatus in certain embodiments.

Each part of the apparatus may have any suitable thickness. For example, a body portion of the apparatus may have a thickness of a quarter inch or more. In some embodiments, the body portion may have a thickness of half an inch or more. The handle may have a thickness suitable for grasping.

Any suitable material may be used for each portion of the apparatus. For example and without limitation, fabric, rubber, plastic, metal, or leather may be used as suitable for any portion of the apparatus. In some embodiments, the body portion may be formed of braided or knitted leather straps and the grabbing end may be made of straight leather strips. Using leather may be advantageous due to its flexibility, relative strength, aesthetic appeal, and ease of gripping with the hands. Having a lightweight and flexible material like leather may also be advantageous in that the apparatus will be less intrusive while hanging from the grab handle than a more rigid apparatus, such as one formed of metal chains, particularly if someone bumps into it.

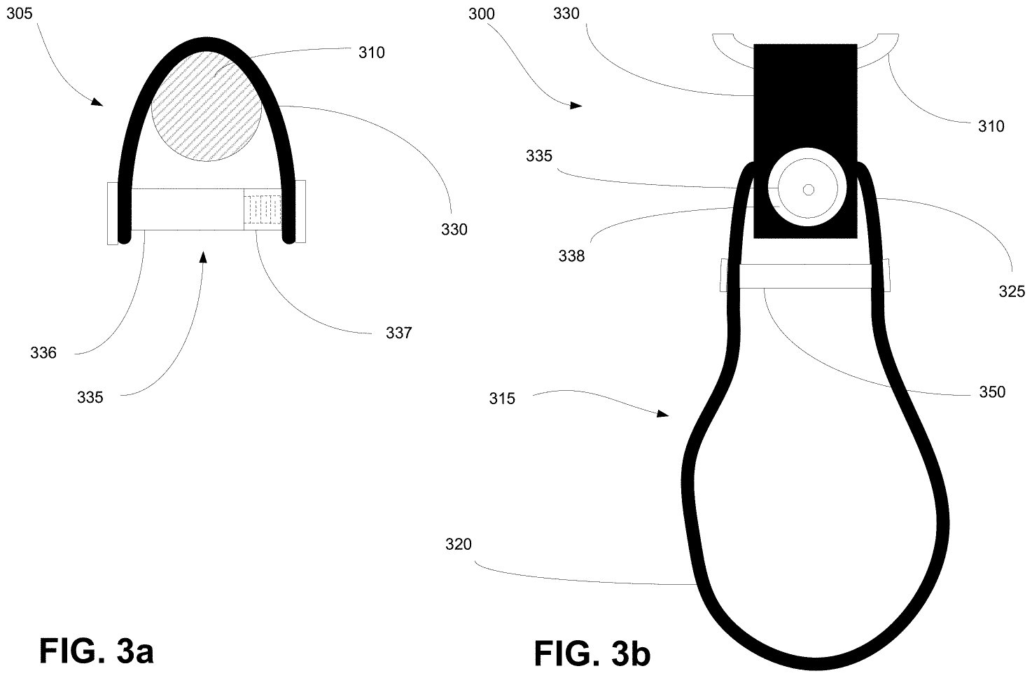

Referring to FIGS. 3a and 3b, an embodiment of an apparatus for assisting a user into a vehicle is shown at 300. The apparatus 300 includes a coupler 305 for coupling to a vehicle's grab handle 310. A handle 315 for a user to grasp and pull themselves up by. The handle 315 is coupled to the coupler 305.

In some embodiments, the handle 315 may compromise a gripping portion 320. The gripping portion 320 may be shaped and sized for grasping by a user. Any suitable shape or size may be used. The handle 315 may also include a coupling portion 325 coupled to the gripping portion 320. The coupling portion 325 is for coupling the handle 315 to the coupler 305.

The coupler 305 may include a first piece 330 for fitting around the grab handle 310, the first piece 330 comprising a bearing surface for bearing against the grab handle 310 when being used by the user. The coupler 305 may also include an attachment piece 335 for attaching each end of the first piece 330 to and for coupling to the handle 315.

The first piece of the coupler may be made of any suitable material, including, without limitation, metal, plastic, fibrous materials, leather, composites or fabric. For example, in some embodiments, the first piece may be made of metal. The metal may be formed into a U shape for fitting around the grab handle. In certain embodiments, the first piece of the coupler may be formed of a piece of leather.

The attachment piece may use any suitable attachment. For example, in some embodiments, the attachment may be made by stitching ends of the first piece together. The ends of the first piece may be riveted together in some embodiments. In certain embodiments, a pin or a bolt may be used as an attachment piece. For example, referring to FIG. 3a, the attachment piece 335 may be a bolt 336 with a cap-head 337 for screwing onto the end of the bolt 336. The attachment piece 335 may be attached to the first piece 330 by passing the bolt 336 through holes in the first piece 330. Grommets 338 may be used to strengthen the edges of the holes.

Using a bolt or a pin as the attachment piece may be advantageous by providing a strong attachment point for both the first piece and the handle. Additionally, having a bolt or pin may allow freer swiveling of the handle relative to the bolt or pin. This may be advantageous because it may allow a user to push the handle away, and in some embodiments, into a storage position, while leaving the coupler low enough for a user to reach it and knock the handle into a usable position. A further advantage of using a bolt or pin as the attachment piece is that it may allow for different handles to be attached to the coupler. The handle may be replaced without changing the coupler. For example, a user may wish to change the handle due to wear. In some cases, a user may wish to use different designs for the handle or have handles of different lengths depending on who may be using the vehicle.

Referring again to FIG. 3, in some embodiments, the coupling portion 325 may comprise a strap for looping around the attachment piece 335. The ends of the strap may be coupled together to form a loop. For example, rivets may be used to join the ends of the strap together.

In some embodiments, as shown in FIG. 3B, a first portion of the strap may be coupled to a second portion of the strap by a second attachment piece 350. The second attachment piece 350 is positioned between the gripping portion 320 and the attachment piece 335 and adjacent to and spaced apart from the attachment piece 335. The second attachment piece 350 may have an axis along the length of the second attachment piece 350 that is transverse to an axis along the length of the attachment piece 335.

Any suitable attachment may be used for the second attachment piece. For example, in some embodiments, a bolt or a pin may be used for the second attachment piece. A tube or small rod may also be used in some cases. In certain embodiments, rivets or stitches may be used.

Attaching the strap portion below the attachment piece is advantageous because it may keep the handle from moving around the attachment piece such that the gripping portion is no longer positioned for gripping. Having the second attachment piece may keep the gripping portion in position for use.

In some embodiments, the handle may form a U shape, with the ends, the coupling portion, coupled to each end of the attachment piece, overlapping with the ends of the first piece of the coupler. For example, the handle may have a first end for attachment to a first end of the attachment piece and a second end for attachment to a second end of the attachment piece. In embodiments where the attachment piece is a bolt, the bolt head and cap may hold the ends in place.

As discussed earlier, any suitable material may be used for the handle, including, without limitation, leather, fabric, metal, composite materials, plastic, and synthetic fibre materials, such as nylon.

In some embodiments, the handle may include an extender between the coupler portion and the handle portion for reversible extension of the apparatus. For example, an adjustable buckle or a slide buckle may be used to extend or shorten the length of a strap that forms the handle.

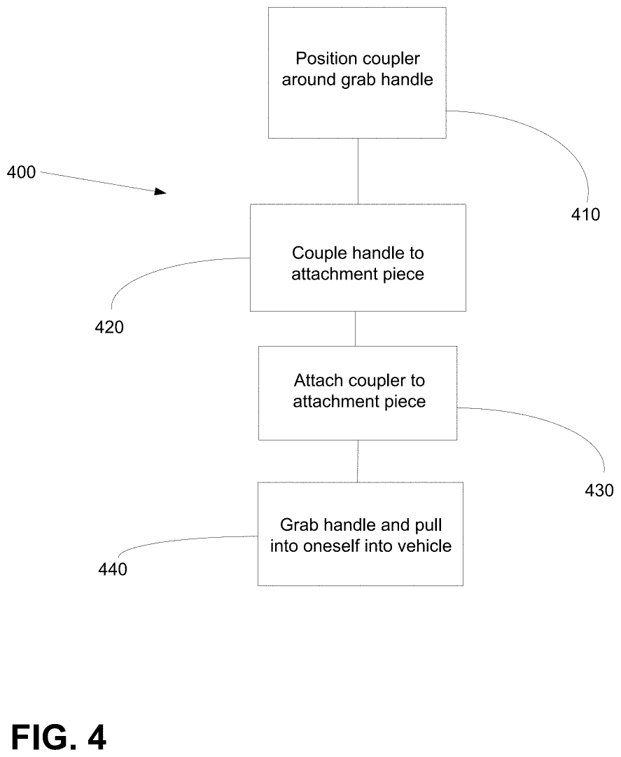

Referring to FIG. 4, a method for attaching an apparatus for assisting a user into a vehicle to a grab handle of the vehicle is shown at 400. At box 410, a coupler of the apparatus is positioned around the grab handle by looping a first piece of the coupler around the grab handle. At box 420, a handle is coupled to an attachment piece. At box 430, the first piece is attached to the attachment piece. At box 440, a user grabs the handle and pulls himself/herself into the car.

In some embodiments, coupling the handle to the attachment piece includes looping a strap of the handle around the attachment piece. In certain embodiments, attaching the first piece to the attachment piece comprises passing a bolt of the attachment piece through a hole in a first end of the first piece and a cap portion of the attachment piece through a second end of the first piece and fastening the bolt to the cap portion.

In some embodiments, a method for coupling an extension to a vehicle grab handle is provided. The method comprises passing a looped section of the apparatus through the space between the grab handle and the part of the automobile that the grab handle is coupled to. Then, the gripping or grabbing end of the apparatus is passed through the looped section until the looped section itself forms a loop or knot around the grab handle.

In some embodiments, a method is provided for climbing up into an automobile. The method comprises coupling an apparatus to the grab handle. The apparatus may act as a grab handle extender and as such, may hang down from the grab handle. A user may grasp the hanging end of the apparatus and use it to assist themselves in climbing into the automobile.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. An apparatus for assisting a user to enter a vehicle, the apparatus comprising:
(a) a coupler for coupling to a vehicle's grab handle;
(b) a handle for a user to grasp and pull themselves up by, wherein the handle is coupled to the coupler;

2. The apparatus of claim 1 wherein the handle comprises:
(a) a gripping portion, wherein the gripping portion is shaped and sized for grasping by a user;
(b) a coupling portion coupled to the gripping portion, wherein the coupling portion is for coupling the handle to the coupler.

3. The apparatus of claim 1 wherein the coupler comprises:
(a) a first piece for fitting around the grab handle, the first piece comprising a bearing surface for bearing against the grab handle when being used by the user; and
(b) an attachment piece for attaching each end of the first piece to and for coupling to the handle.

4. The apparatus of claim 2 wherein the coupling portion comprises a strap for looping around the attachment piece.

5. The apparatus of claim 4 wherein a first portion of the strap is coupled to a second portion of the strap by a second attachment piece, wherein the second attachment piece is positioned between the gripping portion and the attachment piece and adjacent to and spaced apart from the attachment piece and wherein the second attachment piece has an axis along the length of the second attachment piece that is transverse to an axis along the length of the attachment piece.

6. The apparatus of claim 2 wherein the coupling portion comprises a first end for attachment to a first end of the attachment piece and a second end for attachment to a second end of the attachment piece.

7. The apparatus of claim 2 wherein the handle further comprises an extender between the coupler portion and the handle portion for reversible extension of the apparatus.

8. The apparatus of claim 7 wherein the extender comprises an adjustable buckle clip for adjusting the length of the apparatus.

9. The apparatus of claim 3 wherein the attachment piece comprises a bolt and a cap for threading onto the bolt.

10. A method for attaching an apparatus for assisting a user into a vehicle to a grab handle of the vehicle, the method comprising:
(a) positioning a coupler of the apparatus around the grab handle by looping a first piece of the coupler around the grab handle;
(b) coupling a handle to an attachment piece; and
(c) attaching the first piece to the attachment piece.

11. The method of claim 10 wherein coupling the handle to the attachment piece comprises looping a strap of the handle around the attachment piece.

12. The method of claim 10 wherein attaching the first piece to the attachment piece comprises passing a bolt of the attachment piece through a hole in a first end of the first piece and a cap portion of the attachment piece through a second end of the first piece and fastening the bolt to the cap portion.
